(19) United States
(12) Patent Application Publication
(10) Pub. No.: US 2022/0047100 A1
(43) Pub. Date: Feb. 17, 2022

(54) Wall-Mountable Rack with Planar Plate for Receiving Indicia

(71) Applicant: Jesse Lee Jaques, JR., Norman, OK (US)

(72) Inventor: Jesse Lee Jaques, JR., Norman, OK (US)

(21) Appl. No.: 16/995,440

(22) Filed: Aug. 17, 2020

(51) Int. Cl. A47F 7/00; A47F 5/08; G09F 23/00; B65H 75/20

(52) U.S. Cl. CPC A47F 7/005; B65H 75/20; G09F 23/00; A47F 5/08

(57) ABSTRACT

A rack for receiving, storing and dispensing a coiled material, such as but not limited to garden hose, fire hose, gas hose (e.g., oxygen), a chemical hose (e.g. a solvent), electrical cord, cable, chain, or rope, comprising a back plate; a front plate having a back surface and a front surface; and one or more spacing members disposed between the back plate and the front plate such that the back surface of the front plate is faced towards the back plate, thereby creating a space between the front plate and the back plate for receiving the coiled material; wherein the front surface of the front plate is essentially planar and free of non-planar features, thereby providing a uniform flat surface configured for receiving indicia, such as but not limited to affinity indicia, instructions, warnings, specifications and content indications.

### FIELD OF THE INVENTION

The present invention relates to certain improvements in reels and racks for storing and organizing hoses, ropes, chains, and the like, and especially for wall mounted reels and rack which are configured to receive external indicia such as warnings, instructions, logos, advertisements, and images.

### BACKGROUND OF INVENTION

Wall-mount racks and reels for holding garden hoses, fire hoses, tubes, chains, ropes and other materials which are commonly coiled up are well known in the art. These racks and reels are sometimes provided with a decorative appearance, such as appearing to be or actually being manufactured of wrought iron. Other racks and reels are of functional appearance only, having exposed ribs, spokes and reinforcement members that strengthen the rack or reel but otherwise are utilitarian in nature only.

### SUMMARY OF THE EXEMPLARY

### Embodiments of the Invention

A rack is disclosed for receiving, storing and dispensing a coiled material, such as but not limited to garden hose, fire hose, gas hose (e.g., oxygen), a chemical hose (e.g. a solvent), electrical cord, cable, chain, or rope, comprising a back plate; a front plate having a back surface and a front surface; and one or more spacing members disposed between the back plate and the front plate such that the back surface of the front plate is faced towards the back plate, thereby creating a space between the front plate and the back plate for receiving the coiled material; wherein the front surface of the front plate is essentially planar and free of non-planar features, thereby providing a uniform flat surface configured for receiving indicia, such as but not limited to affinity indicia, instructions, warnings, specifications and content indications.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 depicts an example embodiment according to the present invention improved wall-mount rack or reel which provides an essentially flat, feature-free front façade for receiving one or more indicia.

FIG. 2 depicts a rear view of the embodiment according to the present invention of FIG. 1.

FIG. 3 illustrates a front view of the embodiment according to the present invention of FIG. 1.

FIG. 4 shows a top view of the embodiment according to the present invention of FIG. 1.

FIG. 5 illustrates a bottom view of the embodiment according to the present invention of FIG. 1.

FIG. 6 depicts a first side view embodiment according to the present invention of FIG. 1.

FIG. 7 sets forth a side view taken from the opposite perspective of that shown in FIG. 6, being an essential mirror representation of FIG. 6.

FIG. 8 illustrates another example embodiment according to the present invention which provides a square or rectangular façade for receiving one or more indicia.

FIG. 9 illustrates another example embodiment according to the present invention which provides a triangular façade for receiving one or more indicia.

### DETAILED DESCRIPTION OF ONE OR MORE EXEMPLARY EMBODIMENT(S) OF THE INVENTION

The present inventor has recognized that existing reels and racks such as wall-mount racks for hoses, ropes, chains, tubes, steel cables and electrical cords fail to provide an integral panel or façade for receiving indicia such as instructions, logos, advertisements, instructions or other images. As such, some installations of reels and racks may require separate signage, which may or may not be noticed by a user as being associated with the racked or reeled material, especially during an emergency. In other market segments, such as outdoor decorative consumer markets, the consumer may purchase alternative products such as flags, yard signs, banners and wall signs to show affinity or support for a sports team, brand, movement or profession (e.g., first responders, teachers, etc.).

To remedy this unsatisfied need, the present inventor has developed a reel or rack, which we will refer to as a rack hereinafter, which is, in one embodiment, wall mountable, and which provides a planar, essentially feature free façade which can readily receive one or more indicia. By “planar”, we mean essentially continuous, flat, flush, homogenous, smooth, unbroken, uninterrupted, unvarying, or unwrinkled, or a combination thereof. For example, in an industrial application, the rack may be used to hold a fire hose or a hose to deliver a particular liquid or chemical needed in a specific manufacturing step, and as such, signage indicating the content of the hose and/or instructions on how to use the contents and/or open required valves can be readily affixed to the façade portion of the rack. In this manner, a person accessing the hose can readily, quickly and intuitively discern that the indicia or signage relates to the hose coiled on the rack without having the search the wall near the rack to determine which, if any, sign applies to the hose. In another example, a consumer product for holding a garden hose can be provided with indicia to allow the consumer to express affinity or support for a specific sports team, a product brand, a political movement or profession such as teachers, first responders, and branches of the military. In another example, an electrical cord in a workshop environment may be coiled on a rack with indicia on the façade regarding the voltage and amperage of the available electrical source, including necessary warnings. In another example, a hose carrying oxygen for patient use may be racked on a unit having indicia on the façade indicating the contents of the hose and warnings regarding sparks and flames in the area when in use. In another example, a coin-operated hose for a vehicle vacuum at a car wash can be supplied with indicia regarding the price of using the vacuum, instructions on how to start and extend time for using the vacuum, and even instructions regarding allowed uses and prohibited uses of the vacuum. In another example, a rack unit in a retail hardware store may be used to hold chain, tubing, wire, cable or hose for sale by the unit length, such as by the foot, and it may be provided indicia and instructions on the façade regarding the unit price and how to dispense and cut the product.

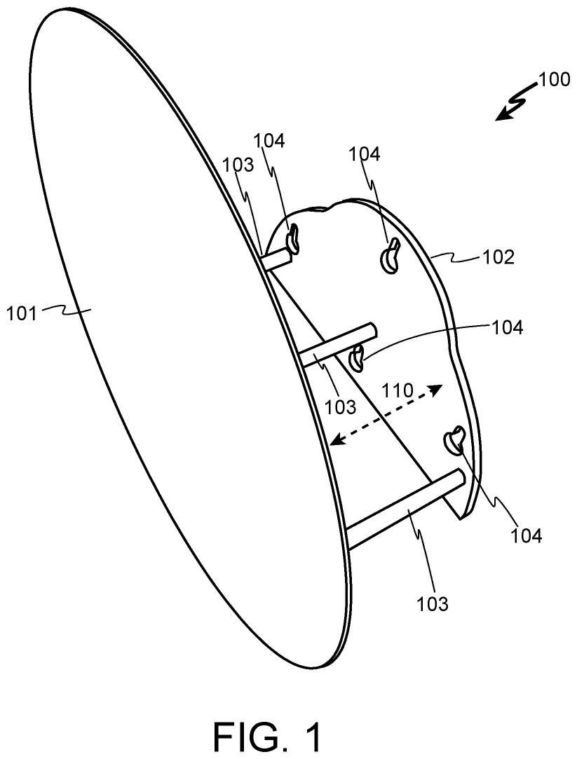

Turning now to FIG. 1, a perspective view of an example embodiment 100 according to the present invention is shown having a rear plate 102 and a circular or oval front plate 101 arranged essentially parallel to each other, spaced 110 apart by one or more horizontal members 103 to provide a gap for receiving a coiled product such as, but not limited to, a hose, rope, chain, tube, steel cable or electrical cord. In this example embodiment, the front plate 101 is flat and feature free so that it can receive one or more indicia by methods such as, but not limited to, screen printing, painting, inking, embossing, debossing, and application of a label. The front plate is of suitable thickness to provide necessary strength to retain the coiled hose on the rack depending on the material of the front plate, such as, but not limited to, plastic (e.g. HDPE, PVC, resin, fiberglass, etc.), metal (e.g. steel, aluminum, etc.), and fiber-based materials (wood, fiberboard, cardboard, etc.). The horizontal spacing members 103 may double in function as the members upon which the received coiled material rests, or a separate material rest may be provided (not shown in this depiction). One or more means for attachment to a wall or cart, such as keyhole cutouts 104, may optionally be provided for embodiments intended for such attachment. The dimensions of all components shown may be adjusted according to the weight and size of the material to be racked and held by the unit.

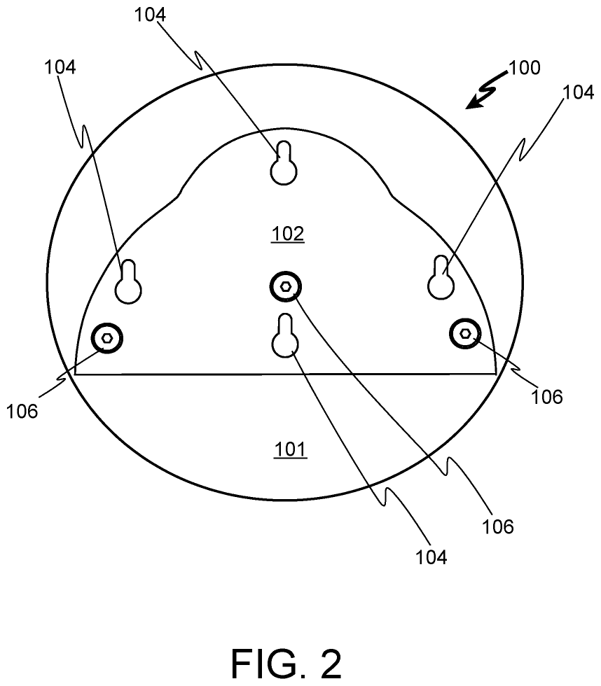

Referring now to FIG. 2, a rear view of the example embodiment 100 of FIG. 1 is shown, including fasteners 106 such as hex-head screws which attach the horizontal spacing members to the rear plate 102. Other means of fastening the horizontal spacing members may be used, of course, so long the means of attachment it is rigid enough and strong enough to support the expected racked material (hose, cord, rope, chain, etc.). Also seen in this view are the one or more keyhole cutouts 104 for attaching the rack 100 to a wall or other vertical support, such as a cart handle.

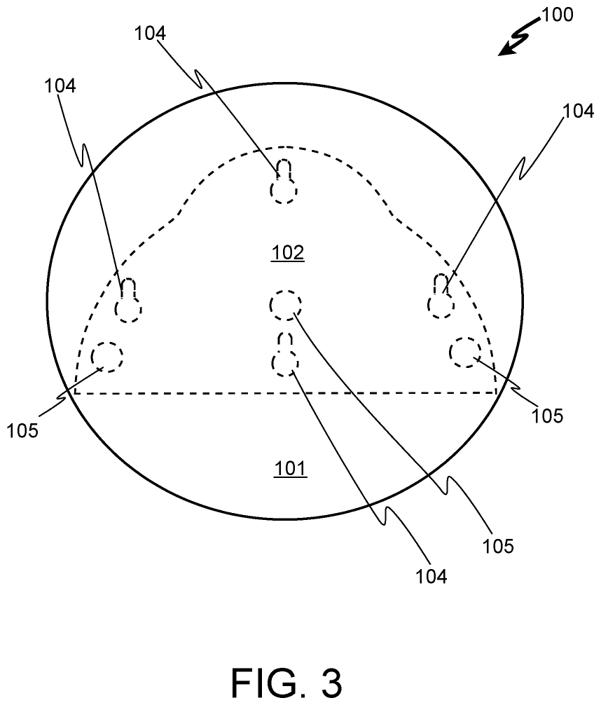

FIG. 3 illustrates a front view of the example embodiment 100 of FIG. 1 in which hidden structures are illustrated with broken lines. In a preferred embodiment, the horizontal spacing members 105 are attached to a back face of the front plate 101 using a means which does not penetrate or disturb a flat, planer and essentially feature-free front face of the front plate 101, such as by welding, gluing, extruding or molding. As such, this allows the front face of the front plate to readily receive a variety of indicia types, including but not limited to screen printing, painting, inking, embossing, debossing, and application of a label. In some embodiments, a slight rim or raised edge around the periphery of the front plate may be provided to protect an edge of the indicia such as vinyl labels.

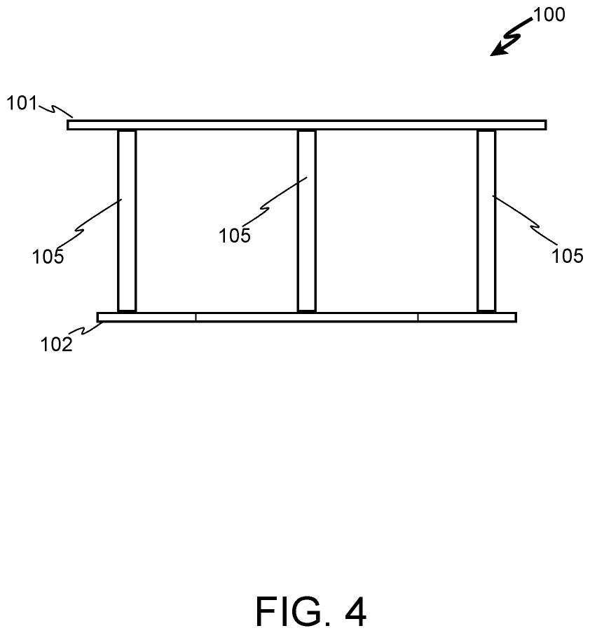

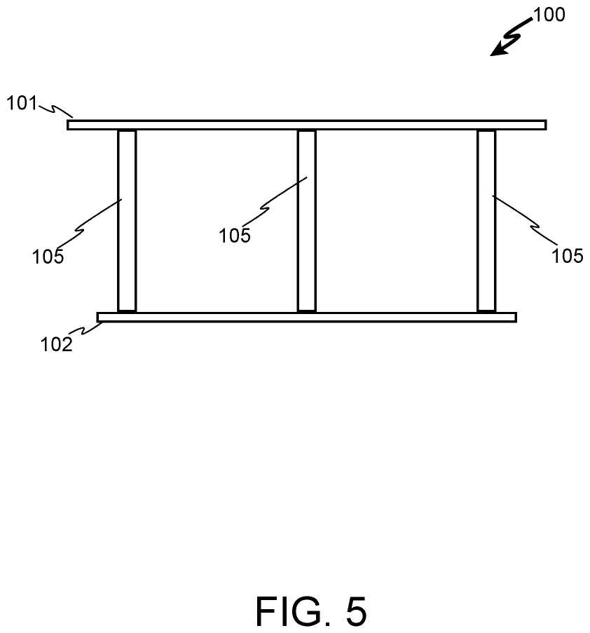

FIG. 4 illustrates a top-down view of the example embodiment 100 of FIG. 1, and FIG. 5 illustrates a bottom view of the same example embodiment.

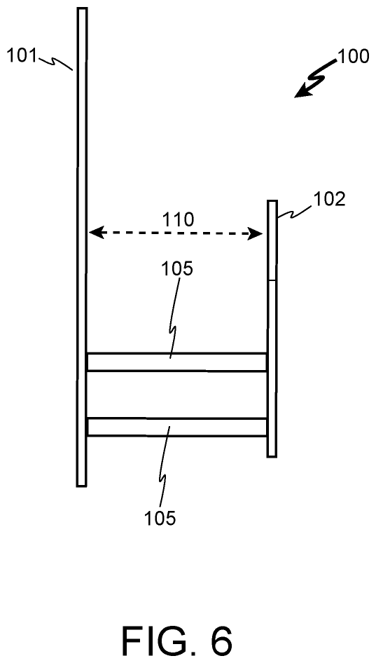

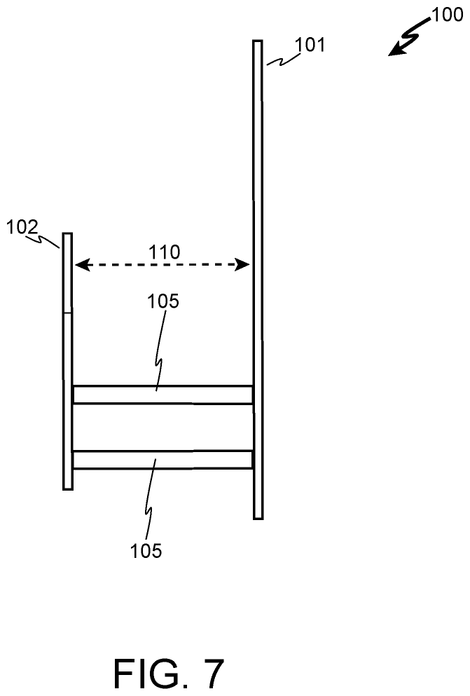

FIG. 6 illustrates a first side view of the example embodiment 100 of FIG. 1, and shows how the center horizontal member 105 can be positioned higher than the other horizontal members to provide a crest or high point to allow the received coiled material (hose, rope, etc.) to be draped downward on either side of the center horizontal member. FIG. 7 provides an essentially mirrored depiction from an opposite side of FIG. 6.

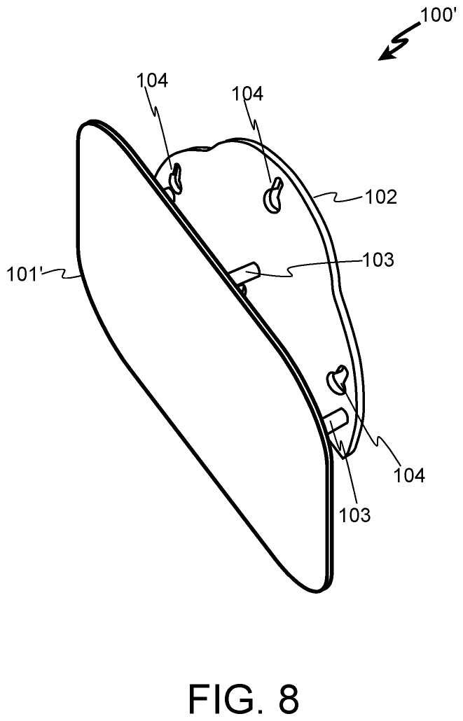

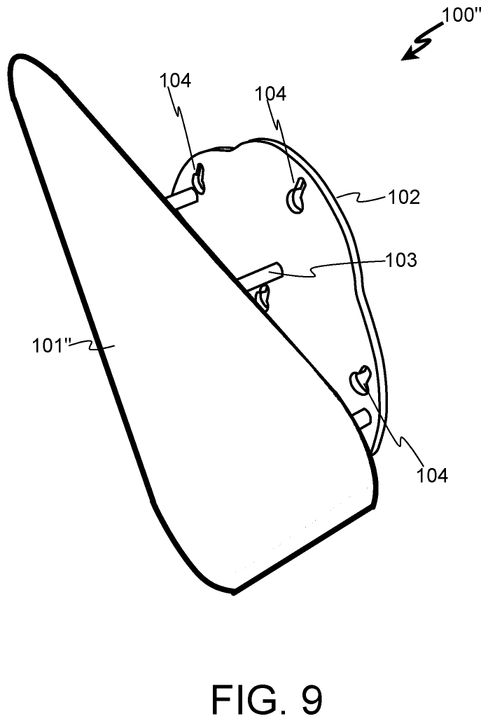

FIG. 8 provides another example embodiment 100′ according to the present invention in which a square or rectangular front plate 101′ is provided to accommodate indicia which is more conducive representation in these shapes instead of oval or round. FIG. 9 illustrates another example 100″ embodiment according to the present invention which provides a triangular façade 101″ for receiving one or more indicia.

In practice, an embodiment according to the present invention is supplied with appropriate indicia on the provided planar front surface of the front panel, is installed on a wall or other type of support, and the used to hold a suitable coiled material such as the forgoing examples of rope, hose, cable, etc. The indicia may be of unrelated nature to the racked material, such as affinity statements, or may be of related nature such as indications of the coiled material's contents, specifications, warnings, and instructions.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A rack for receiving, storing and dispensing a coiled material, the rack comprising:
a back plate having a thickness;
one or more hanging keyhole cutouts provided through the thickness of the backplate;
a front plate having a back surface and a front surface, wherein the entire front surface is configured to receive indicia on at least one contour selected from the group consisting of planar, continuous, flat, flush, homogenous, smooth, unbroken, uninterrupted, unvarying and unwrinkled; and
one or more spacing members disposed orthogonally between the back plate and the front plate such that the back surface of the front plate is faced towards the back plate, thereby creating a space between the front plate and the back plate for receiving the coiled material.

2. The rack as set forth in claim 1 wherein the front plate has a circular shape.

3. The rack as set forth in claim 1 wherein the front plate has an oval shape.

4. The rack as set forth in claim 1 wherein the front plate has a square shape.

5. The rack as set forth in claim 1 wherein the front plate has a rectangular shape.

6. The rack as set forth in claim 1 wherein the front plate has a triangular shape.

7. The rack as set forth in claim 1 wherein the one or more spacing members are configured to receive a garden hose.

8. The rack as set forth in claim 1 wherein the one or more spacing members are configured to receive a fire hose.

9. The rack as set forth in claim 1 wherein the front surface is configured to receive indicia by screen printing.

10. The rack as set forth in claim 1 wherein the front surface is configured to receive indicia by one or more indicia selected from the group consisting of painting, inking, embossing, debossing, and application of a label.

11. The rack as set forth in claim 1 wherein the one or more spacing members are configured to receive a gas hose.

12. The rack as set forth in claim 1 wherein the one or more spacing members are configured to receive a chemical hose.

13. The rack as set forth in claim 1 wherein the one or more spacing members are configured to receive an electrical cord.

14. The rack as set forth in claim 1 wherein the one or more spacing members are configured to receive a cable.

15. The rack as set forth in claim 1 wherein the one or more spacing members are configured to receive a chain.

16. The rack as set forth in claim 1 wherein the one or more spacing members are configured to receive a rope.
